(19) United States
(12) Patent Application Publication
(10) Pub. No.: US 2017/0055596 A1
(43) Pub. Date: Mar. 2, 2017

(54) Smart Clothing for Simulated Touch and Concussive Force

(71) Applicants: Raquel Smith Colby, Woodbridge, CT (US); Paul J. Still, Northport, AL (US); James Sexton, Los Angeles, CA (US)

(72) Inventors: Raquel Smith Colby, Woodbridge, CT (US); Paul J. Still, Northport, AL (US); James Sexton, Los Angeles, CA (US)

(21) Appl. No.: 15/250,655

(22) Filed: Aug. 29, 2016

Related U.S. Application Data
(60) Provisional application No. 62/211,432, filed on Aug. 28, 2015.

(51) Int. Cl. A41D 1/00; A63F 13/24; A41D 31/00; A41D 27/20; A41D 1/04; G09B 19/00

(52) U.S. Cl. CPC A41D 1/002; A41D 1/04; G09B 19/00; A41D 31/0016; A41D 27/20; A63F 13/24

(57) ABSTRACT

A smart clothing device that is utilized for simulated touch and concussive force provides a force simulation element positioned between a rigid outer material and a flexible inner material. The rigid outer material supports the force simulation element and ensures an impact force is directed inwards, towards the flexible inner material. The rigid outer material and the flexible inner material are formed into a garment corresponding to a desired body part upon which the impact force is to be directed. A control unit actuates the force simulation element in response to a command or signal received from a trigger device. The control unit can vary the specific amount of force and the duration for which the impact force is imparted on the desired body part. The trigger device can be any electronic device either running a software program or producing a detectable signal.

The current application claims a priority to the U.S. Provisional Patent application Ser. No. 62/211,432 filed on Aug. 28, 2015.

### FIELD OF THE INVENTION

The present invention relates generally to haptic feedback in clothing. More specifically, the present invention provides a means for smart clothing having force simulation elements that are actuated according to a trigger device.

### BACKGROUND OF THE INVENTION

Training of law enforcement, security and military personnel can be prohibitively expensive and often does not provide the participants with a true understanding of how it would feel to be shot, grabbed, etc. Exposure to such conditions in training can critically improve the chances of survival by training the body how to react to such an event. Some software programs, essentially specialized video games, are utilized to provide a virtual environment for training purposes. While such systems can improve how to react in a situation they do not provide much in terms of haptic feedback, and thus the user is not fully immersed in the situation. Even outside of virtual training programs it is desirable by video game players to be able to feel impact to their bodies that their virtual character is experiencing in the game. The addition of advanced haptic feedback systems to the standard audio and visuals of video games would allow players to become more fully immersed in the virtual environment. Accordingly, there is a need for a system and method that simulates touch, impact, or concussive force.

Therefore, it is an object of the present invention to provide a means of force simulation for law enforcement, security, and military training and to allow digital garners to physically feel the impact of what is occurring in the digital game. The present invention introduces one or more force simulation elements that are placed between two layers of material and worn as clothing. More specifically, the force simulation element is positioned in between a rigid outer material and a flexible inner material that are formed into a garment corresponding to a desired body part. A control unit actuates the force simulation element in response to a trigger device to create an impact force that is directed to an impact region of the desired body part. The trigger device is an electronic device that can be either wired to the control unit or wirelessly coupled to the control unit. Using preset computer programming or an activation signal directed at an external sensor array, the trigger device sends a signal to the control unit to actuate the force simulation element at a specific speed and for a desired duration.

### BRIEF DESCRIPTION OF THE DRAWINGS

FIG. 1 is a front elevational view of the smart clothing device, wherein the rigid outer material and the flexible inner material shaped into a garment to be worn around the torso.

FIG. 2 is a sectional view depicting the force simulation element being positioned in between the rigid outer material and the flexible inner material.

FIG. 3 is a sectional view thereof, wherein the force simulation element has been actuated by the control unit in order to impart an impact force on an impact region of the desired body part.

FIG. 4 is a wiring diagram, wherein the control unit dictates the flow of current from the power supply to the electromagnet upon receiving a signal from the trigger device; the trigger device being wired to the control unit.

FIG. 5 is a wiring diagram, wherein the trigger device is wirelessly connected to the control unit.

FIG. 6 is a wiring diagram, wherein the trigger device sends a signal to an external sensor array that is electrically connected to the control unit.

FIG. 7 is a diagram depicting the garment being positioned about the desired body part, wherein the external sensor array is configured to receive signals from the trigger device.

FIG. 8 is a front sectional view depicting the impact pocket being integrated into the flexible inner material, wherein the impact pocket is partially filled with a dispersible substance.

FIG. 9 is a front sectional view thereof, wherein the electromagnet is engaged with the impact pocket causing the dispersible substance to be distributed throughout the impact pocket.

### DETAIL DESCRIPTIONS OF THE INVENTION

All illustrations of the drawings are for the purpose of describing selected versions of the present invention and are not intended to limit the scope of the present invention.

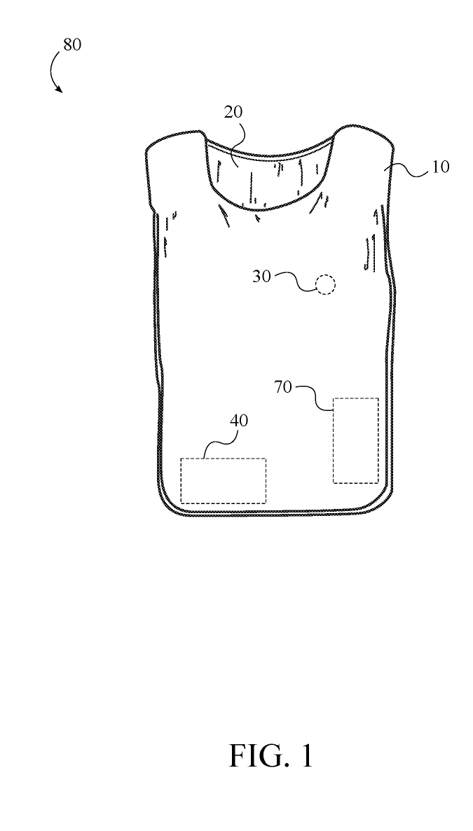

The present invention is a smart clothing device that is utilized for simulated touch and concussive force. In reference to FIG. 1, the present invention comprises a rigid outer material 10, a flexible inner material 20, at least one force simulation element 30, and a control unit 40. The rigid outer material 10 and the flexible inner material 20 are formed into a garment 80 corresponding to a body part. For example, in the preferred embodiment of the present invention, the desired body part 90 is a torso, wherein the garment 80 formed is a vest. The garment 80 is worn by a user on the desired body part 90, wherein the user is able to receive haptic feedback in response to a trigger device 60.

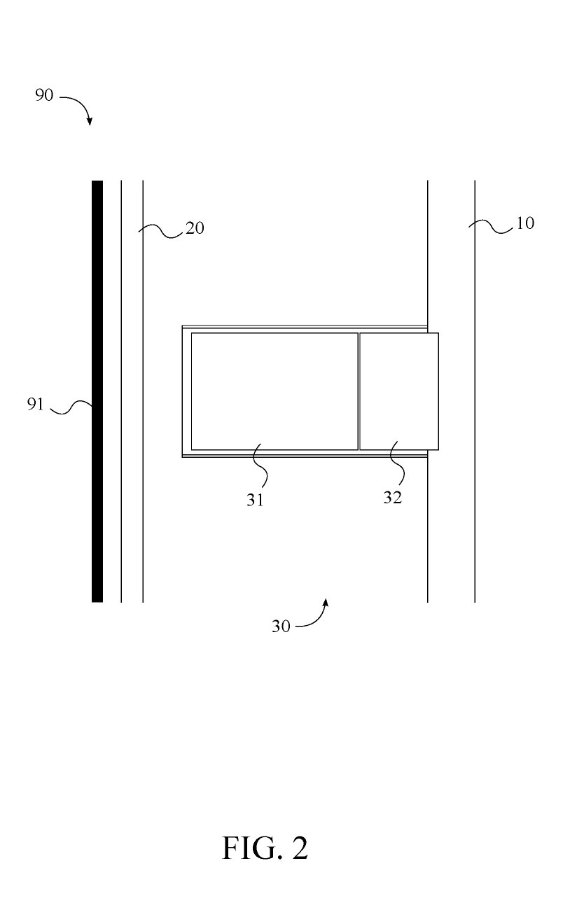

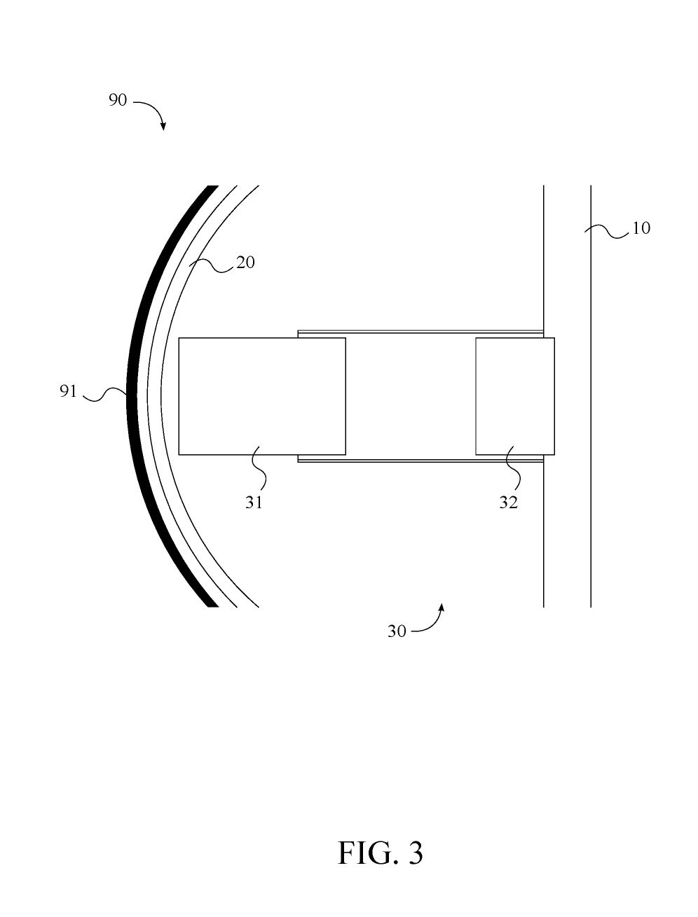

In reference to FIG. 2, in order to provide the haptic feedback, the force simulation element 30 is positioned in between the rigid outer material 10 and the flexible inner material 20. The force simulation element 30 is mounted to the rigid outer material 10, wherein the force simulation element 30 is operably disposed to impart an impact force on the flexible inner material 20. The rigid outer material 10 is sufficiently stiff, such that when the impact force is generated by the force simulation element 30, the rigid outer material 10 is not displaced away from the desired body part 90. Rather, the force simulation element 30 is retained in a fixed position and the flexible inner material 20 is pressed inwards, towards the desired body part 90 in order to impart the impact force onto the desired body part 90, as depicted in FIG. 3.

The force simulation element 30 is operably connected to the control unit 40, wherein the control unit 40 is configured to actuate the force simulation element 30 in response to the trigger device 60. Meanwhile, the force simulation element 30 is configured to apply the impact force to the inner flexible material, and in turn the desired body part 90, when actuated by the control unit 40. The control unit 40 is able to regulate the speed at which the force simulation element 30 is deployed and the duration for which the force simulation element 30 is deployed. As such, the control unit 40 determines the specific amount of force applied and whether the impact force is continuous or isolated.

In reference to FIG. 2-3, in the preferred embodiment of the present invention, the force simulation element 30 is a magnetic device, wherein the force simulation element 30 comprises an electromagnet 31 and a permanent magnet 32. The permanent magnet 32 is mounted to the rigid outer material 10, while the electromagnet 31 is slidably positioned in between the rigid outer material 10 and the flexible inner material 20, and is electrically connected to the control unit 40. More specifically, the electromagnet 31 is slidably positioned adjacent to the permanent magnet 32, opposite the rigid outer material 10. When electrical current, regulated by the control unit 40, is applied to the electromagnet 31, the polarity of the electromagnet 31 is flipped and the electromagnet 31 is displaced away from the permanent magnet 32 and towards the flexible inner material 20 as depicted in FIG. 3.

In another embodiment of the present invention, the force simulation element 30 is a pneumatic device that is operated by the control unit 40. The pneumatic device utilizes a compressed gas to impart the impact force on the flexible inner material 20. As such, a pressurized container and a supply tube are provided to supply the force simulation element 30 with the compressed gas; the compressed gas being stored in the pressurized container and fed to the force simulation element 30 through the supply tube. The impact force may be created by channeling the compressed gas directly into the flexible inner material 20, or by using the compressed gas to drive an impact device into the flexible inner material 20. A valve of the force simulation element 30 is operated by the control unit 40 to regulate the release of the compressed gas.

In yet another embodiment of the present invention, the force simulation element 30 is a piston. The piston is operably coupled to a driver device that is operated by the control unit 40. The driver device can be a servo motor, linear actuator, or any other device that is capable of driving the piston into the flexible inner material 20 in a directionally controlled manner.

The force simulation element 30 is designed to impart the impact force about an impact region 91 of the desired body part 90. Ideally, the force simulation element 30 is relatively small in size in order to reduce the overall size and weight of the smart clothing device. Resultantly, the impact region 91 that is targeted is correspondingly small and the impact force is more concentrated. In order to disperse the impact force and effectively increase the size of the impact region 91, the present invention may further employ an impact pocket 50.

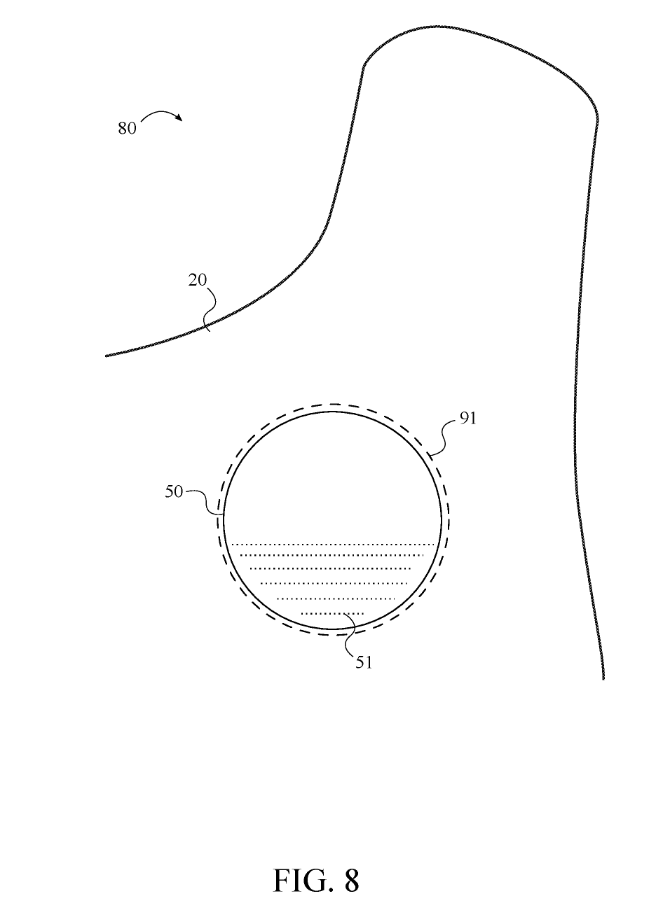

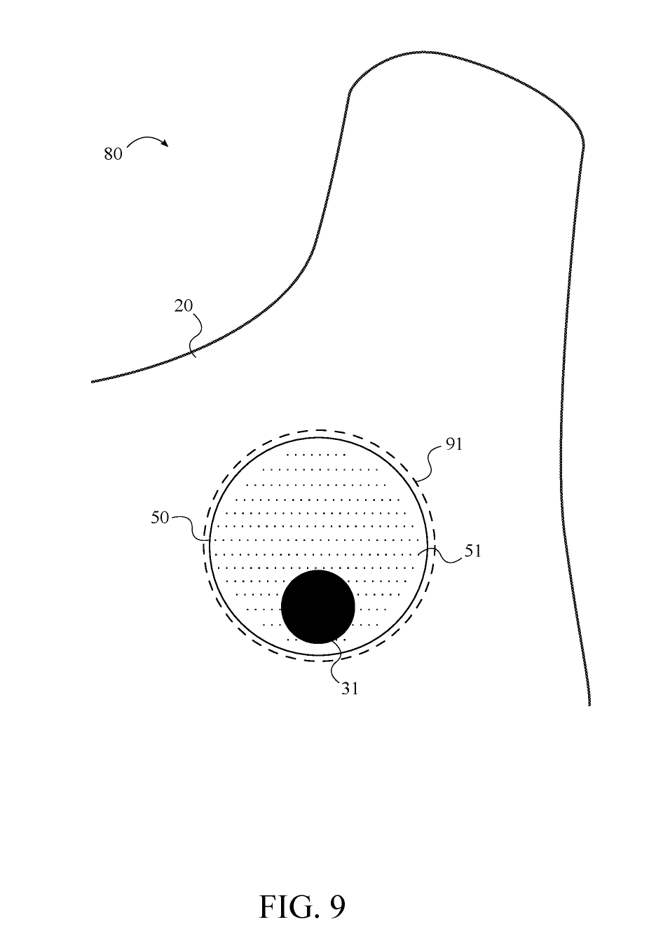

In reference to FIG. 8-9, the impact pocket 50 is integrated with the flexible inner material 20 and is positioned adjacent to the force simulation element 30; the impact pocket 50 can be directly formed into the flexible inner material 20 or integrated about the surface of the flexible inner material 20. The impact pocket 50 is partially filled with a dispersible substance 51 as depicted in FIG. 8, wherein the dispersible substance 51 is distributed about the impact pocket 50 when the impact pocket 50 is engaged by the force simulation element 30 as depicted in FIG. 9. As the dispersible substance 51 is distributed throughout the impact pocket 50, the impact force is effectively less concentrated, being distributed across a larger area, and the effective size of the impact region 91 is increased. The dispersible substance 51 may be a liquid, a gel, a gas, or a combination thereof.

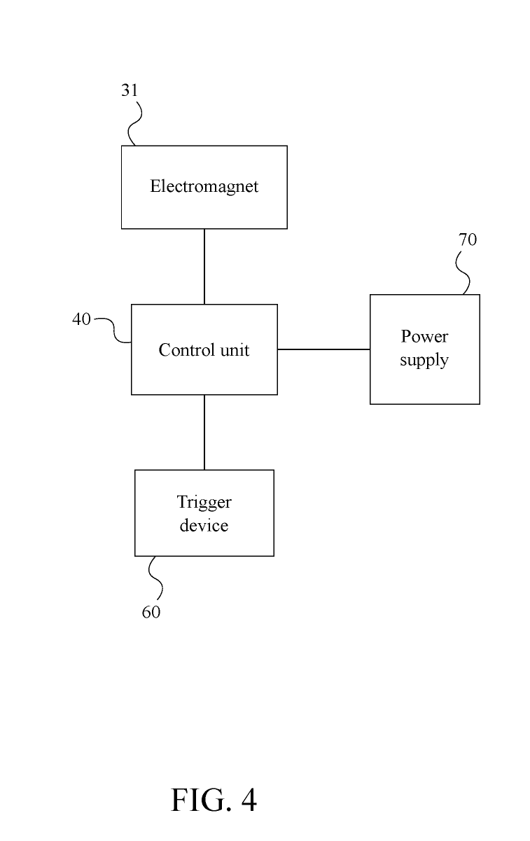

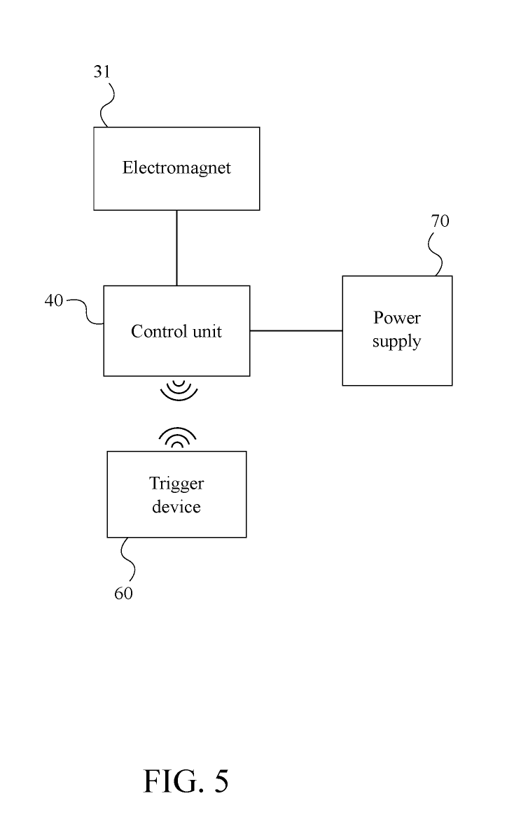

The trigger device 60 can be any electronic device that is communicably coupled to the control unit 40. For example, the trigger device 60 can be a personal computer, a digital game console, a digital communication device, or an online gaming environment. The trigger device 60 may be wired to the control unit 40 as depicted in FIG. 4, or wirelessly coupled to the control unit 40 as depicted in FIG. 5, depending on the embodiment. For wireless coupling, the control unit 40 comprises a transceiver for sending and receiving wireless signals. The control unit 40 receives signals from the trigger device 60, processes the signals, and correspondingly actuates the force simulation element 30.

When utilized with specially programmed software, the present invention can be utilized to provide haptic feedback in the physical world, in response to actions carried out in the digital world. For example, when playing a video game, the force simulation element 30 can produce the impact force on a player in the same area that the player's character was hit in the video game. In other scenarios, the software may be used in law enforcement, security, or military training to allow individuals to simulate the force of being hit with various projectiles. In yet another scenario, the present invention can be used to send a virtual hug, or other virtual touch gesture. The virtual touch gesture can be initiated from a selected command or from another smart device worn or manipulated by an individual in a remote location.

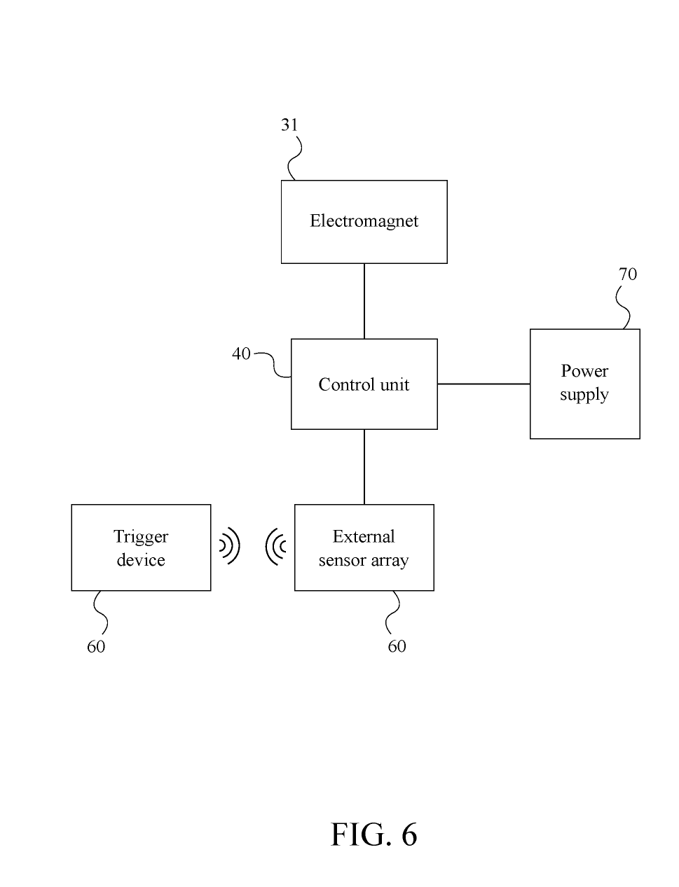

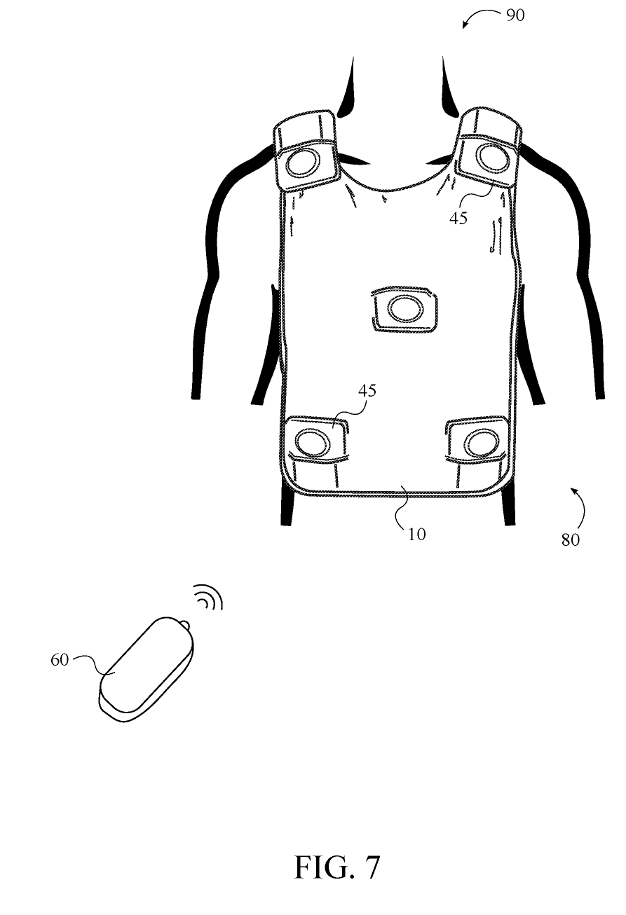

In one embodiment of the present invention, an external sensor array 45 is configured to receive signals from the trigger device 60. In reference to FIG. 7, the external sensor array 45 is integrated into the rigid outer material 10, opposite the force simulation element 30, and is electrically connected to the control unit 40 as depicted in FIG. 6. The external sensor array 45 detects an activation signal or gesture produced from the trigger device 60, and in response, the control unit 40 actuates the force simulation element 30. For example, the external sensor array 45 may include a plurality of photodetectors, such as those used in laser tag, to detect an incoming beam of light. Each of the plurality of photodetectors may be associated with a specific force simulation element or associated with the same force simulation element.

The external sensor array 45 can also include any other sensory device that is capable of detecting parameters of the surrounding environment. For example, the external sensor array 45 can include cameras that are used in conjunction with an image detection software. When specific events or objects are detected by the cameras, the impact force can be generated to alert the user. This is particularly applicable to blind individuals, or other individuals who suffer from disabilities that may impair their ability to be fully and constantly aware of their surroundings.

The control unit 40 comprises a processing unit for interpreting the signals received from the trigger device 60, and may further include a memory unit. Upon receiving the signals, the processing unit accesses the memory unit to determine the specific amount of force to apply and the duration of the impact force. For systems including multiple force simulation elements, the processing unit also determines the specific force simulation element to actuate.

A power supply 70 is provided to supply electric current to the control unit 40 and the force simulation element 30. In one embodiment of the present invention, the power supply 70 is a battery pack that is integrated into the rigid outer material 10 or the flexible inner material 20. The battery pack may be rechargeable, in which a charging port is also integrated into the rigid outer material 10 or the flexible inner material 20, or the battery pack may be non-rechargeable, in which a means is provided for accessing and removing the battery pack. In another embodiment of the present invention, the power supply 70 is a power cord that can be plugged into an outlet in order to supply current. A power inverter may also be provided to convert the alternating current from the outlet to direct current.

Although the invention has been explained in relation to its preferred embodiment, it is to be understood that many other possible modifications and variations can be made without departing from the spirit and scope of the invention as hereinafter claimed.

What is claimed is:

1. A smart clothing device for simulated touch and concussive force comprises:
a rigid outer material;
a flexible inner material;
a force simulation element;
a control unit;
the force simulation element being positioned in between the rigid outer material and the flexible inner material;
the force simulation element being mounted to the rigid outer material;
the force simulation element being operably connected to the control unit;
the control unit being configured to actuate the force simulation element in response to a trigger device; and
the force simulation element being configured to apply an impact force to the inner flexible material when actuated by the control unit, wherein the impact force is continuous or isolated.

2. The smart clothing device for simulated touch and concussive force as claimed in claim 1 comprises:
the force simulation element comprises an electromagnet;
the electromagnet being electrically connected to the control unit; and
the electromagnet being slidably positioned in between the rigid outer material and the flexible inner material.

3. The smart clothing device for simulated touch and concussive force as claimed in claim 1 comprises:
the force simulation element comprises an electromagnet and a permanent magnet;
the permanent magnet being mounted to the rigid outer material; and
the electromagnet being slidably positioned adjacent to the permanent magnet, opposite the rigid outer material.

4. The smart clothing device for simulated touch and concussive force as claimed in claim 1, wherein the force simulation element is a pneumatic device.

5. The smart clothing device for simulated touch and concussive force as claimed in claim 1, wherein the force simulation element is a piston.

6. The smart clothing device for simulated touch and concussive force as claimed in claim 1 comprises:
an impact pocket;
the impact pocket being integrated with the flexible inner material; and
the impact pocket being positioned adjacent to the force simulation element.

7. The smart clothing device for simulated touch and concussive force as claimed in claim 6 comprises:
the impact pocket being partially filled with a dispersible substance; and
the dispersible substance being distributed throughout the impact pocket when the impact pocket is engaged by the force simulation element.

8. The smart clothing device for simulated touch and concussive force as claimed in claim 7, wherein the dispersible substance is a liquid.

9. The smart clothing device for simulated touch and concussive force as claimed in claim 7, wherein the dispersible substance is a gel.

10. The smart clothing device for simulated touch and concussive force as claimed in claim 7, wherein the dispersible substance is a gas.

11. The smart clothing device for simulated touch and concussive force as claimed in claim 1 comprises:
an external sensor array;
the external sensor array being integrated into the rigid outer material opposite the force simulation element; and
the external sensor array being electrically connected to the control unit.

12. The smart clothing device for simulated touch and concussive force as claimed in claim 10 comprises:
the external sensor array being configured to receive signals from the trigger device.

13. The smart clothing device for simulated touch and concussive force as claimed in claim 1 comprises:
the rigid exterior material and the flexible inner material being formed into a garment corresponding to a desired body part.

14. The smart clothing device for simulated touch and concussive force as claimed in claim 13, wherein the desired body part is a torso.

15. The smart clothing device for simulated touch and concussive force as claimed in claim 13 comprises:
the force simulation element being positioned about an impact region of the desired body part.
